(19) United States
(12) Patent Application Publication
(10) Pub. No.: US 2006/0277124 A1
(43) Pub. Date: Dec. 7, 2006

(54) Investment and fund management system and method

(76) Inventor: Alfred F. Gerrietts II, Great Neck, NY (US)

Correspondence Address: REED SMITH LLP, 2500 ONE LIBERTY PLACE, 1650 MARKET STREET, PHILADELPHIA, PA, 19103, US

(21) Appl. No.: 11/142,814

(22) Filed: Jun. 1, 2005

(51) Int. Cl. G06Q 40/00

(52) U.S. Cl. 705/35

(57) ABSTRACT

The present invention relates to an investment method for deploying a long-short strategy that continuously analyzes economic trends and market segments to determine market segments having a likelihood for increasing returns. The method includes evaluating identifiable economic forces acting on capital markets, defining a plurality of segments based on the capital markets, analyzing the forces to determine influence of the forces on at least one of the plurality of defined segments, modeling the influence of the forces on at least one of the plurality of defined segments to assess positions suitable for investment, constructing by a secondary analysis of at least one basket of securities correlated to the plurality of segments, wherein the basket includes at least one of the positions suitable for investment, and managing risk associated with the baskets. The investment method of the present invention may produce consistent returns in a bull, bear, or flat market or market period. The fund strategy may insulate an advisor and a sub-advisor wherein the advisor may be responsible for he marketing and risk management of the fund whereas the sub-advisor may be responsible for stock selection and trading of the fund.

### FIELD OF THE INVENTION

The invention relates to investment systems, and, more particularly, to a long-short relative value investment system and method for producing a high rate of return on a consistent basis. This invention also relates to structures and architectures for implementing the disclosed investment system.

### BACKGROUND OF THE INVENTION

The investing world has historically been, and will continue to be, a volatile environment full of risks and rewards. How investors choose to enter this world is based on individual criteria, and thus many available options and avenues available have been developed for investors. Investors must determine a level of risk they are willing to take on, as well as determine the level of involvement they wish to have in there investments. Also, while some investors may have a solid understanding of equity and fixed income markets, others may understand very little, and simply want a professional to handle their capital.

Regardless of one's expertise in investing, people generally do not have the time to do all of the research that is critical to making sound investment decisions. One reason for the extent of such research is the necessity to understand the multitude of investment and interest vehicles (hereafter collectively referred to as investment vehicles) available to invest money in, including equity interests, funds, which are groups of investment vehicles, debt instruments, and other investment vehicles including but not limited to futures interests, market rights, and regulatory rights. Furthermore, each type of investment vehicle may include many individual vehicles within a type of vehicle, resulting in a plethora of vehicles using many different philosophies and goals needing to be considered by an investor. Because of this, many investment options have been created which put people's investments into the hands of professionals committed to reach the common goals of their individual investors. For example, mutual funds provide an investment vehicle where an investor can invest his or her capital, and a professional management team can make the investment decisions for the investors.

While mutual funds may provide an inherent level of diversity and decreased amount of risk for any particular investor, this system is not without its faults. Funds typically have strict investment policies which define the fund and distinguish them from one another. Such policies are usually highly restrictive in what a particular fund may invest in. For example, a fund may be restricted to large cap equity securities, and thus they cannot invest in companies that have market values of less than 5 billion dollars. Another fund may be restricted to small cap international securities. Other funds may be limited to debt interests, or have restrictions placed on the fund because of the nature of investors in the fund. These sorts of restrictions end up pushing an investor to effectively diversify by holding many funds, to cover what they believe will provide for an adequate investment portfolio. Also, funds are usually long biased or short biased, and therefore cannot take advantage of the specific movements in both directions of different sets of securities. These funds do not have the flexibility to take advantage of the effects of macroeconomic forces which may move subsections of the global market both positively and negatively at the same time.

Investment in securities may include investment by certain qualified U.S. taxable investors. Participation by these investors in a variety of sophisticated financial instruments and transactions may occur. In some cases, the tax rules applicable to such instruments and transactions may be uncertain. In addition, under current U.S. federal income tax laws, such instruments and transactions may create gains and losses which may be either ordinary or capital in nature, or a combination of the two. The character of income, gain or loss as ordinary or capital may vary with the type of transaction. Furthermore, certain provisions of the Tax Code may have the effect of deferring the recognition of losses realized. As would be evident to those possessing an ordinary skill in the pertinent arts, the tax consequences of these and other investment techniques may depend upon particular terms. For example, recognized gain or other income may occur prior to a time at which it is able to be distributed to the U.S. Holders to satisfy a resulting tax liability.

Also, because ERISA imposes certain restrictions on features such as employee benefit plans, entities whose underlying assets include plan assets by reason of a plan's investment in such entities, and on people who have certain specified relationships to plans, certain limitations exist with regard to the securities the investment system of the present invention has been structured to comply with ERISA, and for that matter, all aspects of the law which may be related to investment systems.

Therefore, a need exists for an investment system and method for generating absolute returns with controlled risk within a volatile investing environment, and that may take advantage of economic forces while maintaining sufficient liquidity and transparency in their investment portfolio.

### SUMMARY OF THE INVENTION

The present invention relates to an investment method for deploying a long-short strategy that continuously analyzes economic trends and market segments to determine market segments having a likelihood for increasing returns. The method includes evaluating identifiable economic forces acting on capital markets, defining a plurality of segments based on the capital markets, analyzing the forces to determine influence of the forces on at least one of the plurality of defined segments, modeling the influence of the forces on at least one of the plurality of defined segments to assess positions suitable for investment, constructing by a secondary analysis of at least one basket of securities correlated to the plurality of segments, wherein the basket includes at least one of the positions suitable for investment, and managing risk associated with the baskets.

The method of the present invention may produce consistent returns in bull, bear and flat markets, and is substantially transparent, allowing investors to better understand the investments and returns on investments available through the fund.

Further, the method of the present invention may provide a unique fund structure and organizational model that may separate marketing and securities trading and execution wherein a sub-advisor that may be 40 Act compliant may be primarily responsible for securities selection and trading pursuant to the Advisors overall marketing and specifications where the Advisor may monitor and provide risk management for the fund, thereby separating risk management from the trading of the fund.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts:

FIG. 1a is a generalized schematic of the structural layout of the present invention;

FIG. 1b is an exemplary embodiment of the structural layout of the present invention;

FIG. 2 is an exemplary investment strategy forming part of the present invention;

FIG. 3 is an exemplary risk management model as applied to the investment system of the present invention.

FIG. 4 is an generalized schematic of a information architecture for the present invention; and

FIG. 5 is an exemplary embodiment of the information architecture for the present invention.

FIG. 6 illustrates an embodiment of a fund management structure according to the present invention.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in investment and fund management systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention may generate absolute, attractive returns that may be achieved without regard to market direction, including, for example, through bull, bear and flat markets or market periods. The present invention may also provide consistent returns through utilization of an investment strategy designed to yield predictable results. The present invention may invest in baskets of securities that may have inherent exposure across all markets to minimize company, sector, geographic and other related market risks, or may be concentrated within a specific market segment (i.e., pharmaceuticals, automotive stocks, or agricultural futures. These baskets of securities may also be highly liquid and may allow the investment system of the present invention to accept contributions or calculate redemptions on any trading day without affecting performance of the system.

While a majority of such investments may be in exchange traded equities (ETE's), exchange traded funds (ETF's), exchange-traded closed-end mutual funds and open-end mutual funds, other investment types may be used. ETF's may include baskets of securities that may be traded, and may be passively managed and tracked in a wide variety of sector-specific, country-specific and broad market indices. They may be similar to index mutual funds but may have considerably lower expense ratios, greater tax-efficiency and may be traded throughout the day on major stock exchanges. ETFs may be traded both long and short, may be purchased on margin and require the payment of brokerage commissions.

Exchange traded closed-end mutual funds may issue a fixed number of shares to the public in an initial public offering, after which time shares in the fund may be bought and sold on a stock exchange only. In this regard, they resemble stocks more than open-end mutual funds. Closed-end mutual funds generally do not issue new shares after an IPO and a shareholder may generally not redeem outstanding shares directly with the fund. After the IPO, the price of a share in a closed-end fund may be determined entirely by market demand, so shares can either trade at a discount to, or a premium above, their net asset value.

According to an aspect of the present invention, investments may consist of securities and other assets that may be affected by business, financial markets or legal uncertainties. As with other investments and as would be evident to those possessing an ordinary skill in the pertinent arts, there can be no assurance that an advisor will correctly evaluate the nature and magnitude of the various factors that could affect the value of and return on investments. As may be evident to those possessing an ordinary skill in the pertinent arts, prices of investments may be volatile, and a variety of factors may be inherently difficult to predict, such as domestic or international economic and political developments, which may significantly affect the results and the value of investments.

According to an aspect of the present invention, investments may be directed toward situations to take advantage of pricing inefficiencies among securities, both on an absolute and relative basis. Situational arbitrage and relative value strategies may involve taking long and short positions in securities which have either an economic or mathematical relationship to each other and where a distortion exists between either the historical price or the fair value of that relationship. In other ‘special situations’ where an absolute pricing inefficiency is identified in the price or the fair value of a security, the advisor or a sub-advisor may not have correctly evaluated the value of such security and the circumstances driving the apparent pricing inefficiency, resulting in a possible loss on such investments.

According to an aspect of the present invention, the purchase or sale of an option may be pursued. Purchase and sale of options may involve the payment or receipt of a premium payment by the investor and the corresponding right or obligation, as the case may be, to either purchase or sell the underlying security or other instrument for a specific price at a certain time or during a certain period. Purchasing options involves the risk that the underlying instrument does not change price in the manner expected, so that the option expires and the investor loses its premium. Selling options, on the other hand, involves potentially greater risk because the investor is exposed to the extent of the actual price movement in the underlying security in excess of the premium payment received.

Further according to the present invention, customized options and other derivatives may be purchased or sold in the over-the-counter market which may have features different from traditional exchange-traded options though they also share the same risks. These options and derivative instruments may also increase the risk of default by the counterparty. Investments in these financial instruments may also be subject to additional risks such as interest rate and other risks.

The ability to close out a position as purchaser of an exchange-listed option may be dependent upon the existence of a liquid secondary market on an exchange. Among the possible reasons for the absence of a liquid secondary market on an exchange may be: (i) insufficient trading interest in certain options, (ii) restrictions on transactions imposed by an exchange, (iii) trading halts, suspensions or other restrictions imposed with respect to particular classes or series of options or underlying securities, (iv) interruption of the normal operations on an exchange, (v) inadequacy of the facilities of an exchange or similar facility to handle current trading volume or (vi) a decision by one or more exchanges to discontinue the trading of options (or a particular class or series of options), in which event the secondary market on that exchange (or in that class or series of options) would cease to exist, although outstanding options on that exchange would generally continue to be exercisable in accordance with their terms.

According to a further aspect of the present invention, investments in swaps may be pursued. Investments in swaps may involve the exchange with another party of all or a portion of their respective interests or commitments. Various types of swaps may be entered which may be surrogates for other instruments such as currency forwards, interest rate options, and equity instruments as well as those representing customized baskets of assets and liabilities. The value of such instruments generally depends upon price movements in the underlying assets and liabilities as well as counterparts risk. If there is a default by the counterparty to such a transaction, contractual remedies pursuant to the agreements related to the transaction may be successfully pursued.

The participants in certain markets, such as over the counter markets, may be typically not subject to credit evaluation and regulatory oversight as may be members of ‘exchange-based’ markets. This may increase exposure to the risk that a counterparty will not settle a transaction in accordance with its terms and conditions because of a dispute over the terms of the contract (whether or not bona fide), or because of a credit or liquidity problem, thus potentially causing a loss. Such ‘counterparts risk’ is accentuated for contracts with longer maturities where events may intervene to prevent settlement, or where concentrated transactions occur with a single or small group of counterparties. According to an aspect of the present invention, the advisor may not be restricted from dealing with any particular counterparty or from concentrating investments with one counterparty. The ability to transact business with any one or number of counterparties and the absence of a regulated market to facilitate settlement may increase the potential for losses and gains.

According to an aspect of the present invention, hedging may be used. Hedging is a strategy designed to reduce investment risk using call options, put options, short selling, or futures contracts. Further, long/short selling may also be employed. Long/Short selling is a directional investment strategy that involves investing on both the long and short sides of the market. The objective is not to be market neutral.

Further, investments may be made to attempt to hedge some of the market and credit risks inherent in a strategy, and may seek to utilize various hedging strategies to protect the U.S. dollar value of investments to the extent they may be available, cost effective and appropriate. As may be evident to those possessing an ordinary skill in the pertinent arts, there is no assurance that such strategies, when utilized, will be successful or will not result in losses greater than if the hedge had not been attempted. Hedges may be attempted on individual securities, companies, and currencies as well as on a portion of the portfolio or the portfolio as a whole.

Short sales may, in certain circumstances, substantially increase the impact of adverse price movements on the portfolio. A short sale involves the risk of a theoretically unlimited increase in the market price of the particular investment sold short, which could result in an inability to cover the short position and a theoretically unlimited loss. There can be no assurance that securities necessary to cover a short position will be available for purchase.

Alternative investments may also be utilized. The alternative investment universe consists of investments outside of the traditional market investments of publicly traded debt, equity, real estate and oil & gas. Such alternative investments may include investments ranging from hedge funds and managed futures to venture capital, private placements, and LBO funds.

An asset class may be a group of securities that have similar risk and return characteristics. Examples of asset class categories include: equities, fixed income, cash, and other investments as would be evident to those possessing an ordinary skill in the pertinent arts. Derivatives may be financial instruments that ‘derive’ value from related securities or combination of securities.

Investment may be based on a strategy that categorizes the equity capital markets into market segments and the fixed income capital markets into market segments. Such a strategy may recognize that macroeconomic forces impact market segments in different ways and may analyze how these market segments perform under different market conditions. In addition, the strategy may identify directional shifts and momentum in each market segment. The strategy then may correlate baskets of securities to each market segment and may recommend probabilistically rank-ordered trading decisions in a particular basket of securities.

A historical measure of an investment's sensitivity to market movements, such as beta, may be provided. By definition, the beta of the market (as measured by the benchmark) is 1.0. A beta of less than 1.0 indicates that the investment is less sensitive to the market, while a beta of more than 1.0 indicates that the investment is more sensitive to the market. Generally, the higher the correlation between the investment and the market (as measured by R-squared), the more meaningful is beta. Because beta is based on measurements of past performance, it is not an indication of what the investment's performance will be in the future.

The correlation is a measurement of relationship between two variables. The correlation coefficient (r) shows if there is any correlation between an asset and the market. 1.0 is perfect correlation, 0.0 is absolutely no correlation, and −1.0 s a perfect negative correlation.

Investments in baskets may also be supplemented by investing in investment funds and other securities using other strategies, but only up to a threshold of the investments, such as up to a maximum of 10% of the investments.

An advisor may be responsible for selecting, monitoring and disposing of investments, administration, client services, approving net asset value calculations, trading activity, hedging strategy, overall investment policy, risk management and supervising the activities of the sub-advisor. A sub-advisor may, in conjunction with the advisor, devise the investment strategy, or may simply be part of the advisor.

According to an aspect of the present invention, financial leverage may be used by the advisor because such leverage may be warranted to achieve the optimal rate of return for the level of risk incurred. Financial leverage may be obtained in a variety of ways, including pledging the assets of the investment system or leveraging individual securities with derivatives such as total return swaps, options or using short sales. The amount of financial leverage will vary. While financial leverage may increase the returns, it also has the potential to magnify losses, and therefore the overall losses incurred may be greater than if financial leverage had not been obtained.

According to an aspect of the present invention, the present investing system may be transparent. Transparency may refer to the ability of the investor to look through a fund to its investment portfolio to determine compliance with the fund's investment guidelines and risk parameters, by examining a portfolio's positions. The present invention may, in addition to customary regular reporting, provide detailed current trading activity to investors on at least a daily basis, or even upon request by any particular investor at the investor's convenience. Investors in the system may have unlimited telephone and email access to the advisor or particular fund manager. Investors may also have unaudited NAV performance on at least a monthly basis, unaudited financial statements, management reports, statements of change of investor capital and investor letters on at least a quarterly basis. Further, investors may have audited financial statements, U.S. IRS schedule K1 and other documents used for taxation purposes, and other standard reports on at least an annual basis.

Investments may use leverage by entering into derivative transactions such as total return swaps. In such cases, the valuation of the notional principal contracts may be consistent with the fair valuation methodology described herein. In case of a total return swap, the present invention may involve breakage fees, as would be evident to those possessing an ordinary skill in the pertinent arts, if the total capacity available to an investment under the program is not used or if the program is terminated earlier than the contracted term. Derivative instruments, including over-the-counter options, may be valued using a derivatives pricing model, or may be valued using quotations obtained from unaffiliated market makers and other financial institutions that engage in such derivatives transactions.

By investing in baskets of securities that correspond to specified market segments, the present invention may produce attractive absolute returns, as well as provide a consistency of returns, low volatility and preservation of capital. The present invention may provide absolute attractive returns that may be achieved without regard to market direction, and without regard to any bull, bear and flat phase market. Consistent returns may be provided through utilization of the present invention's investment strategy that yields predictable results. By investing in baskets of securities that may have inherent exposure across all markets, the present invention may minimize company, sector, geographic and similar market risks. With investments in baskets of securities that may be highly liquid, the present invention may accept contributions or calculate redemptions on any trading day without affecting performance.

The present invention may offer limited partnership interests. All such limited partners may participate in investments of the present invention, and may be created such that each has equal dividend, distribution and liquidation rights, as set forth in a governing agreement, such as an agreement for a particular fund within the present invention. Any interests may be registered in the name of the limited partner and may be held in book form.

The present invention may establish and maintain a separate account, such as a capital account, for example, for each partner in a particular fund. The initial balance of a partner capital account may be equal to the initial cash contribution to that fund with respect to such capital account. At the end of any fiscal period, such as a day, month, or year, by way of non-limiting example only, the balance of a partner capital account may be increased. Further, a fiscal period may be the period commencing on any day interests in a particular fund may be issued, on any day on which a partner makes additional capital contributions to that fund, on each day following a day on which a partner withdraws its interests, in whole or in part, or on the first day of any calendar quarter and ending on the day immediately prior to the next date any of the foregoing occurs or on the termination or final liquidation of that fund, or such other period as determined by the general partner. For example, the balance may be increased by any amount contributed to a particular fund for such capital account in cash during such fiscal period, or by the fair market value of any property, other than cash, contributed to that fund for such capital account during such fiscal period, which may be the net of any liabilities assumed by that fund or to which such property may be subject. Increases in balance may also occur through allocations to such capital account of any net profit during such fiscal period, or the amount of any credit to such capital account during such fiscal period made in the discretion of that particular fund to equitably allocate withdrawal charges, and expenses of that fund such as amongst the partners, and in the case of a general partner, for any reallocation to the general partner such as may be required for any incentive fee.

The balance of a partner capital account may be decreased, such as, for example, by the amount of any withdrawals by a particular fund from such capital account during such fiscal period, or by the fair market value of any property distributed to the partner from such capital account during such fiscal period. Decreases in balance may also occur through allocations to such capital account of net loss, or by the amount of any debit to such capital account during such fiscal period made in the discretion of the particular fund to equitably allocate withdrawal charges, interest on hot issues, and expenses of that fund among the partners, for example, and in the case of partners other than the general partner, any reallocation to the general partner as required for any applicable incentive fee, by way of non-limiting example only.

Realized and unrealized increase in the net asset value of a particular fund, after liabilities of any sort, whether contingent or otherwise, reserves and expenses of any sort, from the beginning of the fiscal period to the end of such fiscal period, excluding from such calculation the increase due to any capital contributions made during such fiscal period, the decrease due to any distributions or withdrawals made during such fiscal period and any accruals or allocations of any incentive fee may be defined as the net profit.

Realized and unrealized decreases in the net asset value of a particular fund, after liabilities of any sort, whether contingent or otherwise, reserves and expenses of any sort, from the beginning of the fiscal period to the end of such fiscal period, excluding from such calculation the increase due to any capital contributions made during such fiscal period, the decrease due to any distributions or withdrawals made during such fiscal period and any accruals or allocations of any incentive fee may be defined as the net loss.

According to an aspect of the present invention, Interests may not typically entitle limited partners to vote on any particular matter, except in the case such votes may be for the termination of certain agreements, such as an investment management agreement, or of amendments to governing agreements of particular funds within the system, as set forth herein.

The net asset value of a fund within the system may be the value of the share of the assets of the particular fund owned by a master fund that may be owned by the particular fund, including all unrealized gains or losses, reduced by all liabilities, computed in accordance with standards known to those possessing an ordinary skill in the pertinent arts, such as GMP, for example, except as otherwise noted herein. The net asset value of an interest at any date may be the net asset value of the particular fund divided by the number of interests then outstanding.

The assets within the system and any fund forming part thereof may be valued on a ‘marked-to-market’ basis. Securities that are listed or quoted on a national or regional securities exchange may be valued at their last sales prices on the primary market on the day of determination, or if no sale occurred on such day, then at the mean between the ‘bid’ and ‘asked’ prices on such day, or if no such prices were quoted on such date, the closing price on the most immediate prior date on which such prices were quoted as may be evident to those possessing an ordinary skill in the pertinent arts. Other securities for which the advisor determines that the market value does not properly reflect its true value in the system for any reason, such as due to liquidity or other factors, may be assigned such values as the advisor shall determine with the assistance of an administrator. Also, any values assigned to securities and other assets and liabilities by the advisor may be final and conclusive as to all partners of the system. The net asset value may be calculated by the administrator, with the review and approval of the advisor, taking such valuation and deducting from it all liabilities of the system including, for example, accounts payable, custodial, agency, audit and legal fees accrued, accrued management fees and incentive fees, gross acquisition consideration for assets contracted to be acquired, accrued interest, and any other liabilities of the system. The net asset value will form the basis on which subscriptions and withdrawals may be made.

Securities, assets and liabilities may be valued based upon fair market value or other measure understood by those skilled in the art. An independent appraiser may also be hired to determine fair market value. Any auditor of the system may perform agreed procedures with respect to any calculation or application of the fair valuation methodology employed by the system.

In connection with any determination of the net asset value, the advisor may consult with and may be entitled to rely upon any advice of the administrator, custodians and/or brokers. However, according to an aspect of the present invention, the general partner, the administrator, custodians, brokers or the advisor may not incur any individual liability or responsibility for any such determination made or other action taken or omitted by them in good faith.

According to an aspect of the present invention, the system may contain categorized equity capital markets and fixed income capital markets into a number of segments. Such a strategy may recognize that macroeconomic forces may impact these market segments in different ways and thus such categorization provides for more accurate analysis of how these market segments may perform under variable market conditions. Additionally, the strategy employed by the system may identify directional shifts and momentum in any particular market segment. Output of all buy and sell signals may be probabilistically rank ordered.

As information from external sources may be limited and/or unreliable, research and analysis of any particular industry and the capital markets may be made by any component of the system. For example, elements of the trading strategy may be validated by daily and weekly reports that may include technical and fundamental market research, securities categorization and analysis of price movements of particular baskets of securities and their associated market segments. A database of pricing information may be maintained, and may augment for the system the knowledge, research and experience analyzing and investing in the mutual fund industry.

Portions of the system may have long-standing relationships with mutual fund managers, analysts, broker/dealers and financial advisory professionals. Through regular discussions with these individuals, such relationships may assist in better rationalization of publicly-available information about investment funds and the capital markets. Publicly-available investment funds and other market data may be analyzed, and such analysis may be used to create internal reports for the system.

The present investment strategy may use “value”, based on acquiring out of favor securities whose prices do not yet reflect the companies' intrinsic value and/or may be ‘under-followed’ by analysts.

Volatility may be examined as well. Volatility is the measure of the degree of dispersion of returns around the mean. Volatility is one of several investment risks.

The system may make its investments in the United States, as well as overseas, as they may have better developed markets, which may lead to greater transparency, liquidity and legal certainty.

The system may make investments denominated in non-U.S. currencies, and may utilize hedging strategies to protect the U.S. dollar value of its investments, if necessary.

The system may also borrow money or otherwise use leverage as the advisor deems appropriate, to carry out any portion of the strategies of the system.

The system may use a proprietary trading model to isolate portfolio alpha while minimizing beta. It may be an appropriate investment for both high net worth individuals and institutional investors seeking a conservative approach to providing consistently superior long term returns.

The system may be highly liquid, and may or may not have redemption fees. The system may also provide portfolio and/or trading data on a frequent basis, such as weekly, or even daily, and thus may provide a higher level of transparency to the system as compared with other investment systems. Such transparency may provide investors with a more easily understandable determination of the investment guidelines, risk parameters and use of leverage for the system. such visibility may be provided based upon the real time monitoring provided by the second level of filtering, and may be provided in association with that second level of filtering. The high level of liquidity and visibility may allow the system to scale up its assets rapidly, and without affecting its consistent returns. For example, the system may scale up, or increase the fund's growth up to a capacity of 5 billion dollars, without disrupting the strategy, performance, and/or consistency of the returns of the system.

Any particular fund within the system may make a private placement of its interests to any number of investors. These investors may also be limited, for example, to those who meet a minimum initial subscription of $1,000,000. The general partner may waive or change such a limitation, for example, such as by decreasing the minimum initial subscription to $100,000. Additional subscriptions may be in an amount acceptable to the general partner.

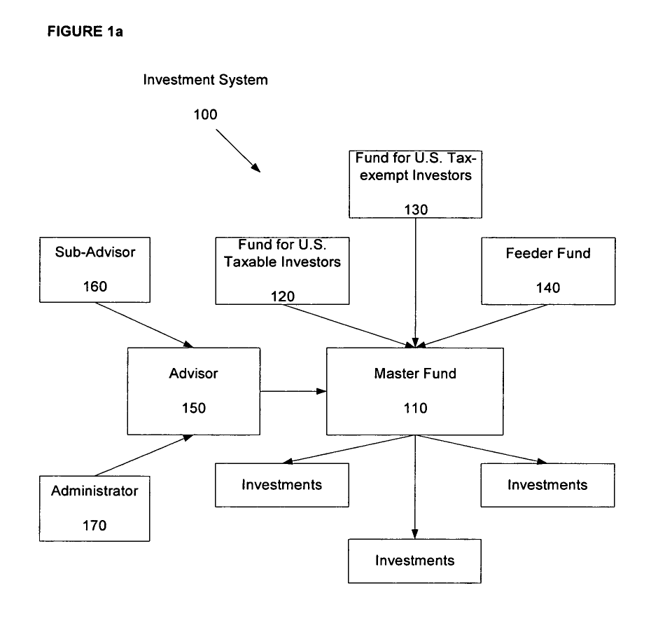

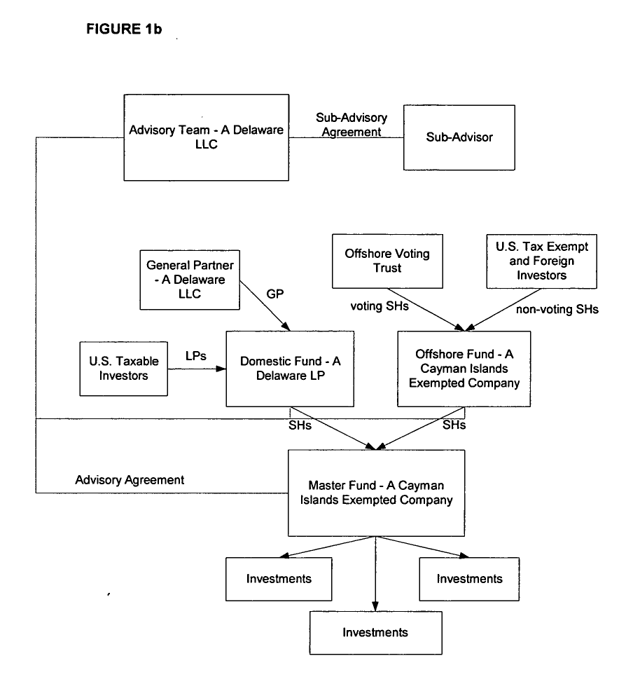

Referring now to FIG. 1a, an investment system 100 designed for financial investment is described. Such investors in investment system 100 may be, for example, individual people, investment groups, or any form of business entity suitable for making investment of capital. Investment system 100 may qualify or limit investors, for example, to those having a particular net worth, or to those above a particular threshold income. Investors of investment system 100 may be limited in other ways as well as would be evident to those possessing an ordinary skill in the pertinent art. Investment system 100 may incorporate a variety of funds, such as a Delaware limited partnership for U.S. taxable investors 120, a Cayman Islands exempted company 130 for U.S. tax-exempt and foreign investors, as well as any additional feeder funds 140 to accommodate other categories of investors. It should be understood that any number of funds may be included in investment system 100. These funds may be further incorporated into a master fund 110. Interests for any funds within system 100 may be offered in either separate or joint offerings, in accordance with any laws applicable to such funds. According to an aspect of the present invention, system 100 may be reorganized by Advisor 150.

Funds 120, 130 and 140 may invest all or any portion of their assets in master fund 110, and may also invest assets directly in other investments, which may be determined by an Advisor 150 to system 100. As a result, the performance of any particular fund may be different from the performance of other funds included in system 100.

Advisor 150 may provide investors with access to absolute return strategies that have historically been able to outperform market returns. Advisor 150 may be any advisor, as understood by those in the art, having a high degree of analytical, investment and operational expertise in managing fund strategy, as well as having the necessary core technical skills, performance track records and experience in alternative investments.

A sub-advisor 160 may be a registered advisor under the Investment Advisors Act, for example, and may be or form part of advisor 150. Advisor 150 may devise the investment strategy of investment system 100. Sub-Advisor 160 may assist advisor 150 with the investment strategy at the discretion of advisor 150. Certain duties of advisor 150, such as, for example, selecting, acquiring, monitoring and selling investments, may be delegated to sub-advisor 160 pursuant to a sub-advisory agreement, discussed in further detail below. However, advisor 150 may also be responsible for selecting, monitoring and disposing of investments, administration, client services, approving net asset value calculations, trading activity, hedging strategy, overall investment policy, risk management and supervising the activities of sub-advisor 160. Other activities may fall under the purview of advisor 150 as may be evident to those possessing an ordinary skill in the pertinent arts.

As illustrated in FIG. 1b, an exemplary corporate structure for system 100 is described. The Domestic Fund is a Delaware limited partnership designed primarily for investment by qualified U.S. taxable investors. The Offshore Fund is a Cayman Islands exempted company designed primarily for investment by qualified non-U.S. and tax-exempt U.S. investors. Additional Feeder Funds may be established to accommodate certain other categories of investors. The Domestic Fund, the Offshore Fund (and any additional feeder funds) may intend to invest the majority of their assets in the Master Fund.

An advisory board may be elected, and/or may consist of persons selected by advisor 150. Other techniques evident to those possessing an ordinary skill in the pertinent arts may be used to develop an advisory board. The advisory board may meet periodically with advisor 150 to discuss investment strategies, general matters relating to investments, and any other business issues. In an exemplary embodiment of the present invention, the advisory board may not have any authority or responsibility for investments made in system 100. Advisory board may perform superficial tasks such as developing and recommending strategy to advisor 150.

Relationships between the components or entities of system 100 may be governed by written agreements. For example, an advisory agreement may be between, amongst others, advisor 150 and master fund 110. Such an agreement may define that advisor 150 may oversee the investment and reinvestment of the assets of master fund 110 in accordance with the objectives and investment policies of system 100 as set forth therein. Terms of any such advisory agreement may provide for master fund 110 to pay advisor 150 a management fee or other customary fee as would be evident to those possessing an ordinary skill in the pertinent arts. In an exemplary embodiment of the present invention, a management fee may pay advisor 150 an annual fee of approximately 2% of the net asset value of master fund 110. The management fee may be accrued and calculated based on the net asset value, as understood by those skilled in the art, of master fund 110 as of the first business day of each calendar quarter, and before deduction of the quarterly management fee payment, and before accrual of any additional fees, such as incentive fees, if applicable. The management fee may also be paid in advance and may be prorated for any period that is less than a full calendar quarter. Funds 120, 130 and 140 may pay its pro rata share of the management fee as of the first business day of each calendar quarter. The management fees payable by funds 120, 130 and 140 may further be deducted in computing the net profit or net loss of such funds, respectively. The actual amount of the management fee and the terms of its payment may vary according to industry standards, and by what may be considered reasonable by those skilled in the art. Additionally, any limited partner may be responsible for a pro rata share of any management fee payable by funds 120, 130 and/or 140, based on the partner capital account. Advisor 150 may waive or reduce the management fee payable by any limited partner, and may vary the terms of the management fee as to any limited partner by agreement with such limited partner.

In addition to management fees, advisory agreements may have other provisions, such as, for example, the agreement may be effective for five years from the date master fund 110 begins operations, and may be automatically renew for additional one-year terms. Other provisions may also provide for termination of the advisory agreement, for example, by advisor 150 at any time with 30 days prior written notice to master fund 110. In another example for termination of the advisory agreement, a resolution adopted by a majority or more of the investors, based on capital account balances, of master fund 110 voting together for termination at the end of each or any successive one-year term with 90 days prior written notice to master fund 110. For such a vote, capital account balances held by any investors affiliated with a general partner or advisor 150 may be excluded, for example. In the event an advisory agreement is terminated, any sub-advisory agreements, as described below, may also automatically terminate.

Advisory agreements may further provide for master fund 110 to indemnify and hold harmless any person or entity affiliated with master fund 110, such as, for example, advisor 150, sub-advisor 160 and any of their respective affiliates, as well as any officers, directors, managing members, members, shareholders, partners, controlling persons, employees, agents, and legal representatives of any of such individuals or entities affiliated with master fund 110. Indemnification may be from and against any loss, expense, judgment, settlement cost, fee and related expenses, including attorneys' fees and expenses, costs or damages suffered or sustained by reason of being or having been indemnified or arising out of or in connection with action or failure to act on the part of such indemnified person or entity, unless such act or failure to act was the result of the fraud, willful misconduct or gross negligence of such indemnified person or entity, or such higher standard as may be set forth in any agreement between master fund 110 and any such person or entity.

A sub-advisory agreement may provide for the relationship between advisor 150 and sub-advisor 160, and may contain provisions provided in the advisor agreement described above, and may contain any other provisions specific to the advisor/sub-advisor relationship. By way of non-limiting example only, the sub-advisor agreement may be effective for five years from the date system 100 or any individual fund therein begins operations and may thereafter automatically renew for any number of additional one-year terms. Additionally, the sub-advisory agreement may be terminated by advisor 150 with 60 days prior written notice to sub-advisor 160, and may also be terminated automatically in the event the advisory agreement may be terminated. By way of another example, the sub-advisory agreement may be terminated by sub-advisor 160 after a designated date, upon notice if the aggregate of any sub-advisory fees payable to sub-advisor 160 may be less than a certain minimum amount per calendar year as described in the sub-advisory agreement. Sub-advisor 160 may agree to perform any investment advisory services described in the sub-advisory agreement for the exclusive benefit of system 100 or any component fund thereof, except that sub-advisor 160 may have the right to continue to advise any existing separate accounts that it previously advised, as well as any new accounts, employing any investment strategy which may be distinct from the investment strategy to be employed by system 100 or any component fund thereof. advisor 150 may pay sub-advisor 160 an annual sub-advisory fee for its services as provided in the sub-advisory agreement, for example, equal to 0.5% of the net assets of master fund 110. Any sub-advisory fee may be payable quarterly. Like the management fee, the actual amount of the sub-advisory fee and the terms of its payment may vary according to industry standards, and by what may be considered reasonable by those skilled in the art.

Investment system 100 may include an administrator 170, and the relationship between administrator 170 and master fund 110 may be governed by an administration agreement. Administrator 170 may perform general administrative tasks for master fund 110 or other funds included in system 100, such as, for example, performing administrative and transfer agency functions, maintaining the financial records and registries, calculating the net asset value and supporting certain risk management functions and other tasks as would be evident to those possessing an ordinary skill in the pertinent arts. The administration agreement may provide an administrator fee for its services, and may also provide for indemnification for administrator 170 by master fund 110. Such indemnification may hold harmless administrator 170 against all claims and demands, judgments, fines, costs or damages and proper expenses in connection therewith which may be incurred by administrator 170 or which may be made against administrator 170 in respect of the same sustained or suffered by any third party, except that administrator 170 may not be indemnified against any liability to which it would be subject by reason of fraud, gross negligence or willful misconduct.

Master fund 110 may pay all or any portion of organization, offering and operational expenses as well as other expenses borne by any of funds 120, 130 and 140 on, for example, a pro rata basis with other investors of master fund 110. Operating expenses may include investment related expenses, such as brokerage commissions, research expenses, interest on margin accounts and other indebtedness, borrowing charges on securities sold short, custodial fees, bank service fees, taxes, clearing and settlement charges, legal fees, accounting, audit and tax preparation expenses, fees paid to administrators and other third parties providing administrative, reporting, accounting, back office and/or other similar services, travel expenses in connection with the initial offering, corporate franchise fees, and any expenses relating to the advisory board, for example. Organizational expenses may also be amortized on a straight-line basis over five years, or by any other method understood by those skilled in the art. Financial statements may contain any qualifications to reflect such treatment, as required by governing regulations such as regulations in the U.S. and generally accepted accounting principles (GAAP).

Any expenses incurred by advisor 150 and sub-advisor 160 in providing their management and advisory services to system 100, for example, such as salaries, office space and utilities, telephone and quotation and computer equipment and services and other general overhead, may be borne by advisor 150 and sub-advisor 160. System 100 may be configured to permit advisor 150 to be reimbursed by master fund 110 or other component of system 100 for administrative and other expenses that advisor 150, sub-advisor 160 or their respective affiliates, may incur on behalf of system 100. Compensation for sub-advisor 160 may be borne by advisor 150 as provided in the sub-advisory agreement or otherwise, and compensation for any other sub-advisors retained by system 100 may be borne by master fund 110 or other component of system 100.

Upon written notice to any fund within system 100, any limited partner may have the right to have all or a portion of its interests withdrawn, according to any applicable governing agreement or law. For example, a limited partner may withdraw capital from its capital account at any time following the one year anniversary of such limited partner subscription for interests.

Any such withdrawal may require written notice stating the amount to be withdrawn. Upon receipt of the withdrawal notice, advisor 150 may determine the net asset value as of the close of business on the withdrawal date, and, based on the calculated net asset value, the value of the withdrawing limited partner interest. Any such calculations and determinations may be provided for in the agreement governing the relationship of the withdrawing party and the fund from which the withdrawal occurs. System 100 may also allow the respective fund to waive any notice provisions and otherwise modify any conditions relating to withdrawal, and with regard to any particular limited partner.

Withdrawal requests may be made to advisor 150, for example, by courier or facsimile. In the case of a request via facsimile, an original may follow promptly by courier. The fund withdrawn from may pay 100% of the withdrawal price, which may be the net of any prorated management fee and/or incentive fee and reserves and expenses for legal, accounting or administrative costs associated with such withdrawal, within a predetermined number of calendar days, such as 10 calendar days, for example, from the end of the fiscal quarter in which the withdrawal date occurs. However, the fund withdrawn from may reserve the right to withhold up to a predetermined percentage of the withdrawal price, such as 10%, for example, where any such amount may be payable, with or without interest, until, for example, no later than 30 calendar days after the issuance of the final audited financial statements with respect to the fiscal year in which the withdrawal may be made. Any amounts reasonably withheld and reserved for contingencies or other matters may be distributed as promptly as practicable. Interest typically may not be paid on any portion of the withdrawal proceeds.

In the event a limited partner has made a withdrawal from a particular fund of system 100, that limited partner may be limited or prohibited to reinvest in that fund for a certain period of time, such as three months, unless a general partner gives approval for such reinvestment. Further, the general partner may have the authority to require any fund of system 100 to make a compulsory withdrawal of any or all of a limited partner interests for any reason, or even the absence of any reason, at any time, upon reasonable notice, such as 5 days notice, with such withdrawals being effective on the date specified in any such notice.

The fund withdrawn from may also, upon written notice to the limited partners, suspend any withdrawal rights or the reporting of net asset value, when, in the opinion of advisor 150, a state of affairs may exist, where the disposal of the securities and other assets and liabilities, or the determination of net asset value, may not be reasonably practical or may be prejudicial to the limited partners. Any such state of affairs may occur when, for example, the disposal of investments of that fund may not be reasonably practical or may not be completed in a timely fashion to meet withdrawal requirements and might be prejudicial to the limited partners. Another exemplary situation may be when any stock exchange on which a substantial part of the securities owned by that fund may be traded is closed, for some reason other than for ordinary holidays, or any dealings thereon might be restricted or suspended. Yet another exemplary situation may be when requests for withdrawals which have been made may not be lawfully satisfied by that fund in appropriate currency. Yet another exemplary situation may be when there may be a breakdown in the means of communication normally employed in determining the prices of a substantial part of the investments of the fund in question.

While system 100 may utilize unique long, short, and long-short relative value investment strategies, system 100 may also incorporate or combine its investment strategies with any of those strategies understood by those skilled in the art.

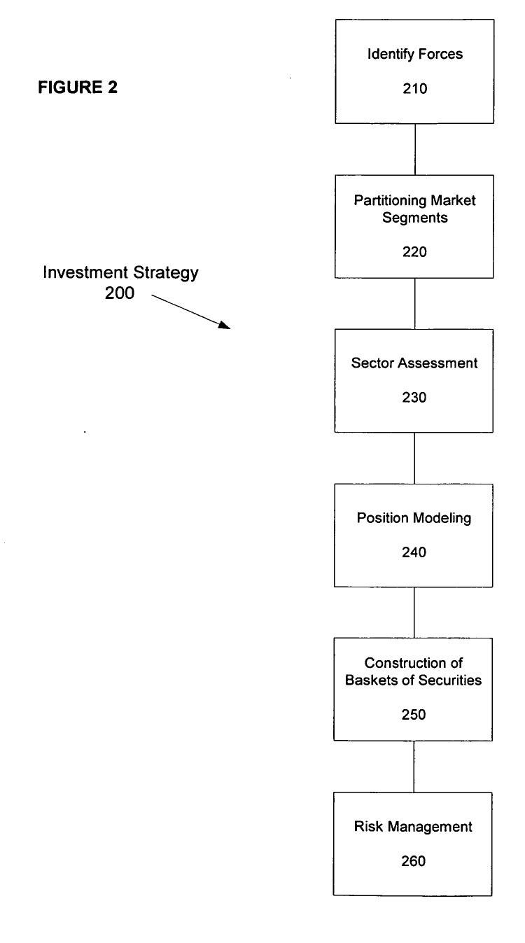

As seen in FIG. 2, an exemplary investment strategy 200 for system 100 is described. System 100 may utilize a long-short strategy that may continuously analyze economic trends and the financial markets for determining which sectors or sub-sectors across various industries and asset classes may offer superior returns. Strategy 200 may include identifying forces 210, partitioning market segments 220, assessing force impact on sectors 230, modeling long/short positions for segments 240, creating baskets of securities 250, and managing risk 260.

Identifying forces 210 which may be capable of moving prices in the capital markets on a sustained basis may be evaluated. For example, major macro-economic trends may be identified, such as secular and cyclical trends, economic growth, inflation, currency movements, interest rates, Federal Reserve policy and corporate profits, for example. This step may be premised on the belief that the forces that move any particular market segment of the equity and fixed income capital markets up and down may be primarily macro-economic in nature and may be taken into account when making an investment decision.

Partitioning securities 220 may be partitioned into market segments. The equity and fixed income universes of securities may be partitioned into any number of market segments. For example, the equity capital markets may be categorized into numerous segments, such as more than 150 market segments, for example, and the fixed income capital markets into numerous segments, such as more than 40 market segments, for example. These segments may be filtered through a trading model to evaluate relevant market forces 210 and anticipate the potential impact on such forces on any particular segment or sector. Trading model inputs may be based on the principles of classical technical analysis as understood by those skilled in the art, and may be derived within system 100 or from an independent source.

Each equity market segment may be derived from major market indices. The basis of this derivation may be on a variety of characteristics, such as statistical correlation, market capitalization, growth/value gradation and sector weighting. For example, when making a statistical correlation, the strategy may include the analysis of the relative statistical performance, such as price and volatility, of each major market index and its statistical correlation to any other major market index or indices. When using market capitalization, component securities of each major market index may be categorized by gradations in market capitalization. The performance of those component securities may be measured, compared or correlated relative to the overall performance of its major market index. In addition, the component securities of each major market index may be compared against one another to the extent they exhibit a similar market capitalization or other similar trait to gauge relative performance. When looking at a growth/value gradation, the component securities of each major market index may be categorized by gradations in growth or value. The performance of those component securities may then be measured relative to the overall performance of its major market index. Additionally, the component securities of each major market index may be compared against one another to the extent similar growth/value characteristics or other similar traits to gauge relative performance are exhibited. When using a sector weighting strategy, the component securities of each major market index may be categorized by relative sector weighting in ten basic industry sectors, or any number or combination of basic industry sectors deemed appropriate. The performance of those component securities may be measured relative to the overall performance of its major market index. Also, the component securities of each major market index may be compared against one another to the extent a similar sector weighting or other trait to gauge relative performance is exhibited. Fixed income market segment may be derived in a manner similar to the analysis of the equity markets described above, yet on the basis of characteristics such as yield curve, credit quality, actual yield and maturity/duration, for example.

Force impact on sectors may be assessed 230. Data on how market forces impact each sector or sub-sector of the capital markets may be produced, such as prices moving in different directions and at different times. Similar to forces capable of moving prices in the capital markets on a sustained basis, such as secular and cyclical trends, economic growth, inflation, currency movements, interest rates, Federal Reserve policy and corporate profits, for example, these forces may also impact any particular market segment differently from one another, and so these forces may be evaluated as to their effect on the market segments and sectors, respectively.

Modeling long/short positions for segments 240 may include trading models which may signal long positions for market segments having positive momentum. Such trading models may also signal short positions for market segments which may be overpriced.

Creating baskets of securities 250 may include grouping securities into baskets of securities that may be designed based on correlation with particular market segments. The output of buy and sell signals of securities from modeling 240 may then be filtered into the baskets of securities. While not every buy or sell signal may end up in a basket of securities, those which do fall into any particular basket may be probabilistically ranked and/or ordered within their respective baskets of securities.

Identification of these baskets of securities may be made by a variety of discrete investment characteristics, with each equity basket of securities categorized on the basis of characteristics similar to those used to categorize market segments, such as statistical correlation, market capitalization, growth/value gradation, and sector weighting.

The relative statistical performance of each equity basket of securities may be analyzed against the relative statistical performance of any number of investment funds and major market indices. In one embodiment, for example, over 300 investment funds and over 30 major market indices may be used in such analyses. Behavior, such as performance, volatility and correlation, for example, of each equity basket of securities may be analyzed against any number of investment funds and major market indices. Such analyses may be a first filtering level of any type, such as on the basis of market capitalization alone in order to determine the relative capitalization of that basket of securities. For example, certain small-cap investment funds, such as the Vanguard Small-Cap Value VIPERs and the iShares Russell 2000 Index Fund, may be analyzed to determine capitalization relative to other Investment Funds.

The behavior of each equity basket of securities may be analyzed against any number of growth and value major market indices via the first level filters to determine the gradations in growth or value of each basket of securities. In one exemplary embodiment, over 14 such growth and value major market indices may be used in the behavioral analysis. In another example, certain value investment funds, such as the iShares Russell 3000 Value Index Fund and the iShares S&P Mid-Cap 400/BARRA Value Index Fund, may be analyzed to determine their growth or value characteristics relative to other Investment Funds.

Each equity basket of securities may be analyzed in order to categorize it by relative sector weighting in any number of other basic industry sectors. In one exemplary embodiment, 10 such basic industry sectors may be used in the analysis. In another example, certain health care sector investment funds, such as the Health Care Select Sector SPDR Fund and the Pharmaceutical HOLDRS Trust, may be analyzed to determine their sector weighting relative to other health care sector investment funds.

In an exemplary embodiment, the strategy categorizes security X, which may be a component security of the Russell 2000 index, as a small-cap equity security with value characteristics and a health care sector weighting. The performance of security X may then be measured against other component securities that exhibit small-cap, value and/or health care sector characteristics.

Fixed income baskets of securities may be analyzed and categorized in a similar manner as equity baskets of securities yet based characteristics that may be used to analyze debt market segments, such as yield curve, credit quality, actual yield and maturity/duration, for example.

After identifying a satisfactory number of equity and fixed income market segments, and the characteristics of a satisfactory number of baskets of securities, system 100 may use a screening model to identify momentum in each of the market segments. Depending on the momentum of each market segment, system 100 may choose to be, for example, net long, net short or neutral in any particular market segment. Trading decisions may then be made with respect to the basket of securities, that may correlate to those market segments. Each recommendation may be reviewed and a trading decision made based on that review. Once a trading position may be undertaken, continual monitoring of that position may be based on that continuing research, and a determination may be made when the appropriate time to exit that position may be.

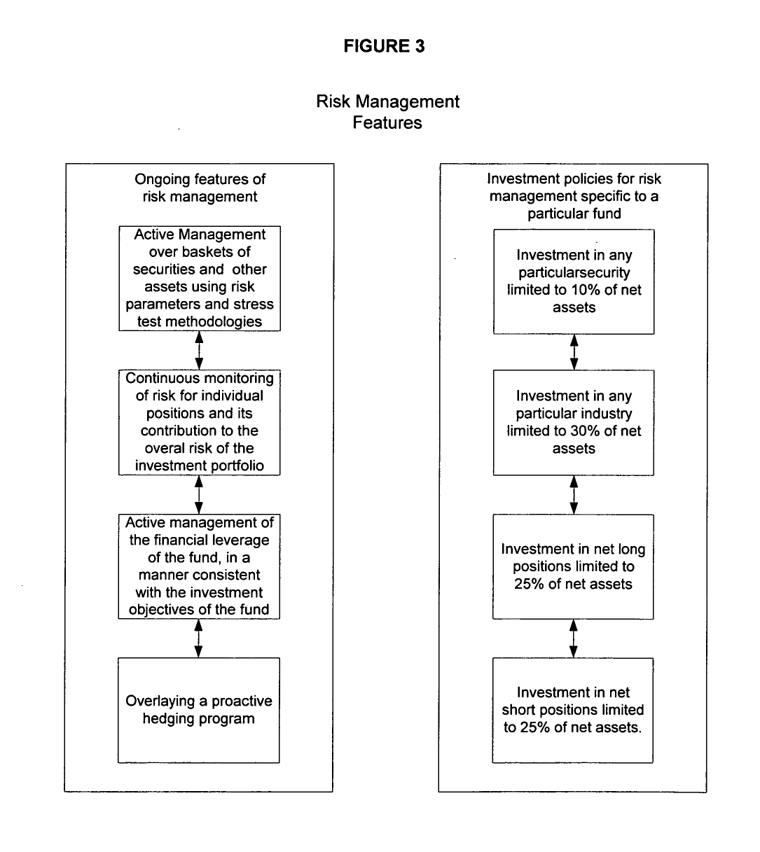

Managing risk 260 may include several ongoing actions as well as investment policies defined for any particular fund. Referring to both FIGS. 2 and 3, such risk managing features may include, for example, actively managing the baskets of securities and other assets against risk, via risk parameters and stress test methodologies. Advisor 150 may continuously monitor the risk of each individual position as well as its contribution to the overall risk of the investment portfolio and may actively manage the financial leverage of system 100 in a manner consistent with the overall investment objective of system 100. Advisor 150 may also overlay a proactive hedging program, such as a second level of filtering in series or parallel with a first level of filter or filters, to manage some of the market and currency risks for the holdings within system 100.

Investment policies may be established for the investments made within system 100. For example, system 100 may limit its long investment in any security to a certain percent, such as 10%, for example, of net assets. This limit may be determined at the time of investment, or at any other time deemed appropriate to advisor 150. System 100 may also limit its net investment in any single industry to a certain percent, such as 30%, for example, of its net assets. This limit may also be determined at the time of investment, or at any other time deemed appropriate to advisor 150. System 100 may also limit each of its net long and net short positions to a certain percent, such as 25%, for example, of its net assets. This limit may also be determined at the time of investment, or at any other time deemed appropriate to advisor 150. Other features of risk management may be applied to system 100, such as setting stop-loss parameters for any particular trade, maximizing percentage draw-down and position size limits based on the total positions of a particular fund, the relative weighting of position limits based on correlations between securities, market segments and the total portfolio of positions, continuously “back-testing” to validate any particular parameter of the trading model used, overlaying of strategies used to manage trading risk of any particular investment manager, monitoring capital at risk to system 100 from individual positions on a real time basis, and using options strategies to manage risk, for example.

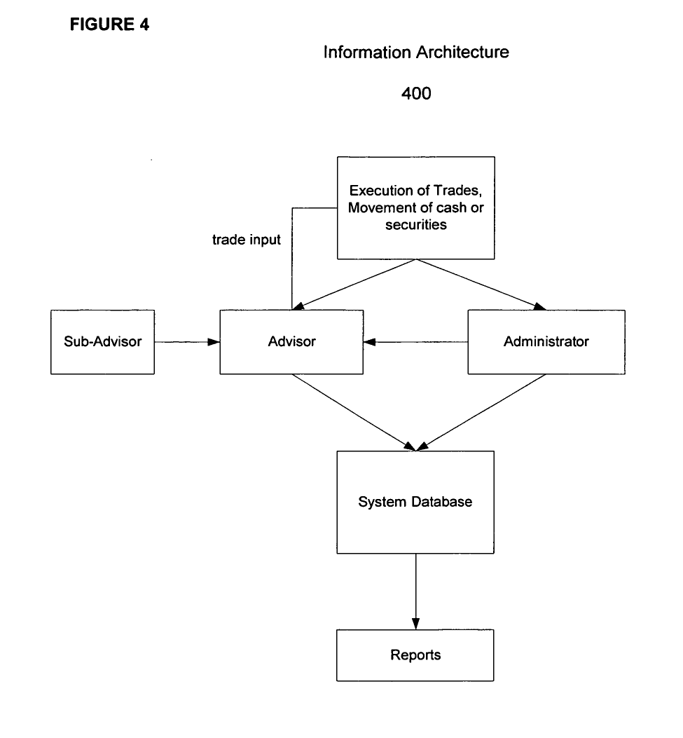

Referring now to FIG. 4, there is shown a generalized information architecture 400 of investment system 100 of FIG. 1. Architecture 400 may include an advisor, sub-advisor, administrator and outside inputs. The advisor or sub-advisor may input trades, balance daily blotters, coordinate financing and input executed orders. The advisor may monitor access to the databases and provide reports. The advisor may further provide daily trade file and daily reconciliation. The administrator may receive a feed detailing the trade execution, cash and other securities movements and custody changes. Further, the administrator may monitor access to the database while providing daily reconciliation to the advisor.

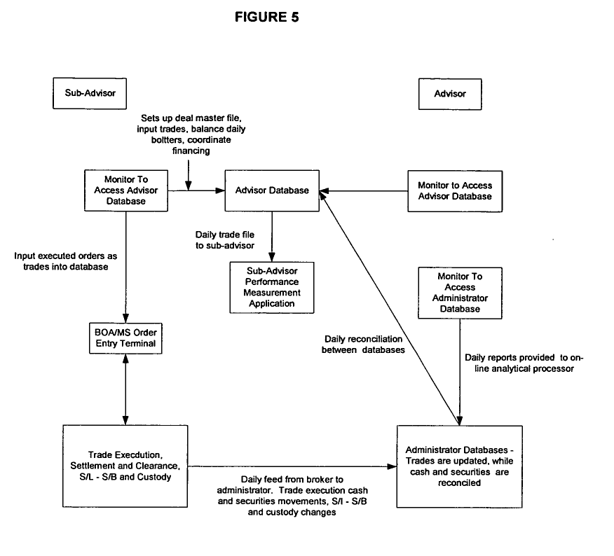

As may be seen in FIG. 5, an exemplary embodiment of information architecture 400 is shown. The roles and steps associated with the process may be segregated into sub-advisor functions and advisor functions. The sub-advisor may monitor a market strategy identified by the advisor. The market strategy may include information identifying the amount of funds invested into the hedge fund, as well as other parameters associated with the risk-management strategy of the fund. The sub-advisor may utilize a database to manage this information. Information generated by the sub-advisor, such as monitoring criteria, may be communicated to the advisor for inclusion in an advisor database used by the advisor for managing the hedge fund. The sub-advisor may identify desired purchase and/or sales of investment vehicles, and generate instructions for changing the composition of a hedge fund through an order entry terminal which may be in communication with a broker. The broker may then implement the instructions provided by the sub-advisor.

The results of transactions accomplished by the broker may be communicated to the sub-advisor and the advisor for inclusion in monitoring systems used by the advisor and the sub-advisor. The advisor may utilize the gathered information to monitor the impact of the instructions issued by the sub-advisor on the overall composition of the hedge fund in view of the risk management strategy of the hedge fund, and adjust the market strategy being followed by the sub-advisor as necessary.

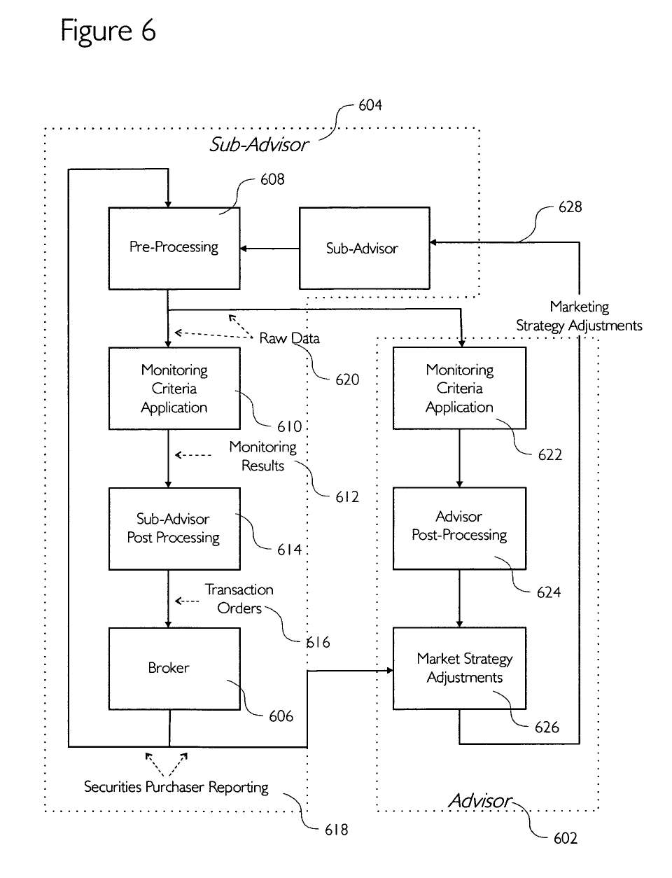

As shown in FIG. 6, a structure may be implemented using an advisor 602, a sub-advisor 604, and one or more securities purchasers or brokers 606 to accomplish the purchase and sale of investment vehicles for inclusion in a fund. By disassociating the roles of the advisor and sub-advisor, certain limitations of an advisor only system may be avoided.

The sub-advisor may be responsible for the selection of individual investment vehicles for incorporation into the fund in accordance with a marketing strategy provided by the advisor. The advisor may be responsible for determination of a risk management strategy compliant with investor and regulatory requirements, and a market strategy implementing the risk management strategy into goals for the composition of fund properties.

As the sub-advisor is responsible for individual selections, the sub-advisor may use a tool or tools to allow tracking of investment vehicles for potential inclusion into the fund, and/or the tracking of investment vehicles which are already components of the fund. This tracking may be accomplished using a pre-processing tool 608, such as a computer program or spread sheet which simplifies or automates the tracking of the investment vehicles.

The sub-advisor may further develop metrics for analyzing the potential merit of including an investment vehicle into the fund, hereafter referred to as monitoring criteria. These monitoring criteria may be applied 610 to an information stream associated with investment vehicles to generate monitoring results 612 which identify or characterize the merit of including an investment vehicle into the fund. Application 610 of these monitoring criteria may be accomplished by the sub-advisor manually, or through the use of an automated tool such as a software tool or spreadsheet. Alternately, the monitoring criteria may be provided to a tracking service, such as Bloomberg or Dow Jones, such that the monitoring criteria can be applied to a stream of information regarding the trades of the investment vehicles, such as through a public exchange.

The monitoring results may be used by the sub-advisor to allow the sub-advisor to generate transaction orders 616, such as instructions to adjust the composition of the fund by purchasing or selling a position as a percentage of the position. The generation of transaction orders may be implemented by the sub-advisor using an automated tool to process the monitoring results into a format amenable to review by the sub-advisor to allow the sub-advisor to more readily identify and accomplish changes to the composition of the fund.

Transaction orders 616 may be generated through conversion of composition change instructions into the frame of the positions held by the fund. For example, an instruction to reduce a percentage of the fund held in a specific market segment may result in a determination of how much of the position is being presently held, followed by an instruction to a broker to liquidate a portion of that position commensurate with the desired reduction of the portfolio composition.

The transaction orders 616 may be received by the broker 606, who may implement the transaction orders and report 618 the results of the purchase or liquidation of a position to the sub-advisor.

To allow the advisor to manage the selections of the sub-advisor, raw data 620 such as the monitoring criteria may be provided to the advisor, who may concurrently apply 622 the monitoring criteria to an information stream associated with investment vehicles to allow the advisor to have the same monitoring results which identify or characterize the merit of including an investment vehicle into the fund. Alternately, the monitoring results themselves may be provided to the advisor to allow the advisor to monitor the composition of the fund. Additionally, the output of the broker may also be provided to the advisor, such that the advisor is able to concurrently view the status of the fund composition.

This information may be utilized 624 to adjust 626 the market strategy provided to the sub-advisor, to allow the advisor to control the relation between the composition of the fund and the advisors risk management strategy associated with operation of the fund. The advisor may them communicate 628 desired adjustments to the market strategy to the sub-advisor, who may incorporate the changes into the monitoring criteria.

As is evident from the above, the control of the fund composition by the sub-advisor allows automated scaling of the size of the fund, with the advisor or broker responsible for ensuring that the amount of a particular investment vehicle held by the fund is commensurate with the gross amount invested in the fund by investors and the fund composition controlled by the sub-advisor.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. An investment system for deploying a long-short strategy that continuously analyzes economic trends and financial markets to determine financial market segments likely to exhibit increasing returns in bull, bear or flat markets or market periods, said system comprising:
a master fund filtered from a plurality of available investments, said master fund composed of a plurality of other funds;
an advisor for managing said master fund and for directing the continuous analysis, including selecting of the ones of the plurality of available investments for said master fund and for selecting said plurality of other funds; and,
an administrator for facilitating the managing of the system by said advisor.

2. The system of claim 1, wherein said plurality of other funds includes at least one United States based investment and at least one offshore investment.

3. The system of claim 1, wherein said master fund is divisible into selected, filtrated ones of said financial market segments.

4. The system of claim 1, wherein said master fund is an offshore fund.

5. The system of claim 1, wherein said plurality of other funds includes investments selected from the group consisting of bonds, stocks, derivatives, options, real property, debt, cash reserve and currency.

6. The system of claim 1, wherein said advisor, said sub-advisor and said administrator are directed by at least one written agreement.

7. The system of claim 1, wherein said advisor, said sub-advisor and said administrator are directed each by a unique agreement.

8. The system of claim 1, wherein said plurality of other funds are partners.

9. The system of claim 8, wherein said partners are limited partners.

10. The system of claim 1, wherein said advisor comprises at least one sub advisor.

11. The system of claim 1, wherein said filtration into ones of said financial market segments includes a plurality of marketed parameters.

12. The system of claim 1, wherein said system evaluates identifiable forces acting on capital markets, defines a plurality of segments based on said capital markets, analyzes market forces to determine the influence of said forces on at least one of said plurality of defined segments, models the influence of said forces on at least one of said plurality of defined segments to signal positions suitable for investment, constructs at least one basket of securities correlated to said plurality of segments, wherein said basket includes at least one position signaled for investment, and manages risk associated with said baskets.

13. The system of claim 12, wherein said at least one basket of securities has inherent exposure across all markets.

14. The system of claim 13, wherein said exposure decreases market risks.

15. The system of claim 12, wherein said at least one basket of securities has high liquidity.

16. The system of claim 15, wherein said system accepts contributions and calculate redemptions on any trading day without diminishing the performance of said system.

17. The system of claim 1, wherein said system generates returns without regard to market direction.

18. An investment method for deploying a long-short strategy that continuously analyzes economic trends and market segments to determine market segments having a likelihood for increasing returns in bull, bear or flat markets or market periods, said method comprising:
evaluating identifiable economic forces acting on capital markets;
defining a plurality of segments based on said capital markets;
analyzing the economic forces to determine influence of the economic forces on at least one of said plurality of defined segments;
modeling the influence of said economic forces on at least one of said plurality of defined segments to assess positions suitable for investment;
constructing by a secondary analysis of at least one basket of securities correlated to said plurality of segments, wherein said basket includes at least one of the positions suitable for investment; and
managing risk associated with said baskets.

19. The method of claim 18, further comprising taking long and short positions in securities which have an economic or mathematical relationship to each other and where a distortion exists between either the historical price or the fair value of that relationship.

20. The method of claim 18, wherein said suitable positions include investable securities.

21. The method of claim 18, wherein said investable securities include equity securities and fixed income securities.

22. The method of claim 18, wherein said plurality of segments include at least 150 segments of the equity market.

23. The method of claim 18, wherein said plurality of segments include at least 40 segments of the fixed income market.

24. The method of claim 18, wherein the basket of securities is a majority of a total of said investment.

25. The method of claim 18, wherein said forces include macroeconomic trends.

26. The method of claim 18, wherein said capital markets include equity and fixed income markets.

27. The method of claim 18, wherein said plurality of segments is derived from major market indices.

28. The method of claim 27, wherein said derivation is based on statistical correlation, market capitalization, growth and value gradation, and sector weighting.

29. The method of claim 18, wherein said positions are selected from a further filtered set of positions.

30. The method of claim 18, wherein said at least one basket of securities has inherent exposure across all markets.

31. The method of claim 30, wherein said exposure decreases market risks.

32. The method of claim 18, wherein said at least one basket of securities has high liquidity.

33. The method of claim 32, wherein said method accepts contributions and calculate redemptions on any trading day without diminishing the performance of said method.

34. The method of claim 18, wherein said method generates returns without regard to market direction.

35. The method of claim 18, wherein said method seeks to generate absolute returns uncorrelated with traditional equity and bond markets.

36. The method of claim 18, wherein said method seeks superior alpha while maintaining a beta close to zero.

37. An investment method for deploying a long-short strategy that continuously analyzes economic trends and financial markets to determine segments for increasing returns, said method comprising:
evaluating identifiable forces acting on capital markets;
defining a plurality of segments based on said capital markets;
analyzing market forces to determine the influence of said forces on at least one of said plurality of defined segments;
filtering a set of positions;
modeling the influence of said forces on at least one of said plurality of defined segments to signal said filtered positions suitable for investment;
constructing at least one basket of securities correlated to said plurality of segments, wherein said basket includes at least one position signaled for investment; and
managing risk associated with said baskets.

38. A method for managing risk in a fund that utilizes a long-short strategy that continuously analyzes economic trends to market segments to determine market segments having a likelihood for increasing returns, and to baskets of securities correlating to the market segments, said method comprising:
actively managing the baskets of securities and other assets against risk using risk parameters and stress test methodologies;
continuously monitoring the risk of each individual position in the fund as well as its contribution to the overall risk of the investment portfolio;
actively managing the financial leverage of the fund in a manner consistent with the investment objectives of the fund, and
overlaying a proactive hedging program

39. The method of claim 38, wherein investment in any security is limited to up to about 10% of net assets.

40. The method of claim 38, wherein investment in any industry is limited to up to about 30% of net assets.

41. The method of claim 38, wherein investment in its net long positions is limited to up to about 25% of net assets.

42. The method of claim 38, wherein investment in its net short positions is limited to up to about 25% of net assets.

43-52. (canceled)
